(19) United States
(12) Patent Application Publication
(10) Pub. No.: US 2012/0205362 A1
(43) Pub. Date: Aug. 16, 2012

(54) Electric Heater and Assembly Therefor

(76) Inventors: Hans-Peter ETZKORN, Bruchsal (DE); Christian Walter, Brettenm (DE)

(21) Appl. No.: 13/372,754

(22) Filed: Feb. 14, 2012

(30) Foreign Application Priority Data
Feb. 16, 2011 (DE) 10 2011 011 366.5

(51) Int. Cl. H05B 1/00

(52) U.S. Cl. 219/201

(57) ABSTRACT

The invention relates to an electric heater for a motor vehicle, the heater includes at least one branch circuit in which a field effect transistor is connected in series to the resistor, and a control circuit for regulating power, wherein the control circuit taps a voltage signal between the field effect transistor and the resistor and, on the basis thereof and in combination with a setpoint value signal, generates an output signal which is present at a control input of the field effect transistor. According to the invention, the resistor is a ceramic PTC resistor which is mounted with the field effect transistor on a common heat sink.

The invention relates to an electric heater for a motor vehicle. A heater of this type is known from DE 197 33 045 C1.

The known heater has a plurality of branch circuits connected in parallel, each containing a field effect transistor which is used as a heating element and is connected in series to a series resistor. The heat output of the field effect transistors is steplessly controlled by changing the voltage present at the gate. The known heater is operated continuously, thereby avoiding the problems of cyclic operation and avoiding EMC problems. However, it is disadvantageous that a relatively large number of expensive field effect transistors is required, especially for a heater having a greater heat output, and that the circuit is not polarized.

The problem addressed by the present invention is that of demonstrating a way to overcome these disadvantages.

This problem is solved by an electric heater having the features defined herein along with. Advantageous refinements of the invention.

### SUMMARY OF THE INVENTION

According to the invention, a field effect transistor is connected in series with a ceramic PTC resistor as a current sensing resistor which is mounted with the field effect transistor on a common heat sink, This has the following advantages:
The heat output of a heater according to the invention is applied in the branch circuits partially by the field effect transistor and partially by the ceramic PTC resistor. Greater heat output per branch circuit is thereby made possible.
Advantageously, the portion of heat output of the PTC resistor to total output is that much greater, the higher the power requirement is that is set by a control voltage. When output is high, in particular, the field effect transistor of a branch circuit is relieved, thereby enabling greater heat output to be released by a heater according to the invention without incurring higher costs for power semiconductors.
The circuit is inherently safe due to the temperature-dependent current limitation of the PTC resistor, even in the presence of mispolarization or a fully alloyed power semiconductor.
Since the field effect transistor and the PTC resistor of a branch circuit are mounted on a common heat sink, optimal thermal coupling results. Therefore, the PTC resistor can effectively protect the field effect transistor against thermal overload, thereby enabling additional temperature monitoring to be omitted.
The heater can be operated continuously since the output can be regulated in a stepless manner. Due to the voltage present at the gate of the field effect transistor, the electrical resistance of the field effect transistor between source and drain can be set to a desired value, thereby steplessly regulating the current intensity. The load on the vehicle electrical system is therefore substantially lower than in motor vehicle heaters operated in a pulsed manner, and electromagnetic compatibility problems do not occur.

Preferably, P-channel field effect transistors, in particular P-channel MOSFETs, are used for a heater according to the invention. Advantageously, a cooling surface on the drain connector of a P-channel field effect transistor can be connected to the same potential as the ceramic PTC resistor connected in series to the field effect transistor. The cooling surface of the field effect transistor and the PTC resistor can then each be connected in an electrically conductive manner to a heat sink made of metal, using clamps, for example. In this manner, very good thermal coupling and heat dissipation can be achieved using simple means.

In a heater according to the invention, the PTC resistor is advantageously used as a current sensing resistor. The current measured therewith can then be used to regulate the heat output of the field effect transistor to a setpoint value. The current can be measured by way of a voltage tapped between the PTC resistor and the field effect transistor. This voltage can be used as a feedback signal for regulating power. Preferably the control circuit used for power regulation contains an operational amplifier, the output of which is connected to the gate of the field effect transistor. A setpoint value of the heat output is then specified by a control voltage at an input of the operational amplifier. The voltage tapped between the field effect transistor and the PTC element is preferably supplied to the other input of the operational amplifier.

The invention furthermore relates to an assembly for a heater according to the invention. An assembly according to the invention contains a P-channel field effect transistor, a heat sink and a ceramic PTC resistor, wherein the field effect transistor and the PTC resistor are connected to the heat sink, preferably being soldered thereto.

### BRIEF DESCRIPTION OF THE DRAWINGS

Further details and advantages of the invention are explained using an embodiment, with reference to the attached drawing. Shown are:

FIG. 1 a heater comprising a branch circuit and an associated control circuit;

FIG. 2 a schematic depiction of an assembly of a field effect transistor, heat sink and PTC resistor; and

FIG. 3 a schematic depiction of a further embodiment of an assembly.

### DETAILED DESCRIPTION

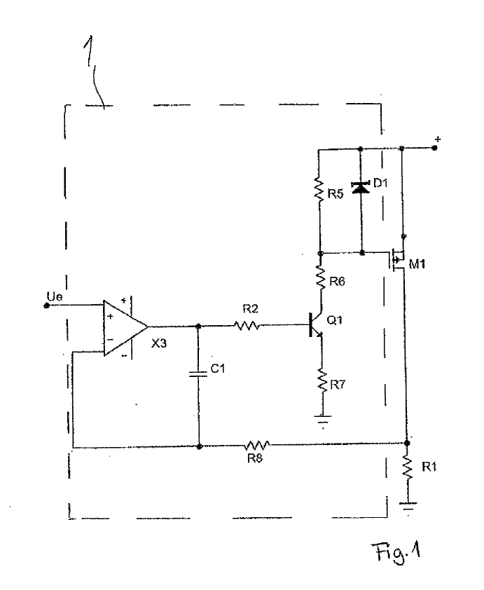

FIG. 1 shows a circuit diagram of an electric heater. The heater contains, as heating elements, a field effect transistor MI and a ceramic PTC resistor R1 which is based on barium titanate, for example. The field effect transistor M1 and the PCT resistor R1 connected thereto in series form a branch circuit, the output of which is regulated using a control circuit 1. To increase the maximum possible heat output, further branch circuits having the same design, including control circuits, can be added to the heater. Any number of such branch circuits can be connected in parallel.

The control circuit 1 mainly comprises an operational amplifier X3. The heat output of the branch circuit is specified by a control voltage Ue which is applied at an input of an operational amplifier X3, preferably at the non-inverting input thereof. A voltage tapped between the field effect transistor M1 and the PTC resistor R1 is applied at the other input of the operational amplifier. In FIG. 1, the input of the operational amplifier X3 is therefore connected to the branch circuit between the field effect transistor M1 and the PTC resistor R1. By way of a resistor R8 connected upstream of the relevant input of the operational amplifier X3, the capacitor C1 can be decoupled, thereby counteracting oscillation.

The operational amplifier X3 is therefore part of the control circuit 1 which supplies the output signal of the operational amplifier X3 to the gate of the field effect transistor M1. In this manner, the intensity of the current flowing in the branch circuit through the field effect transistor M1 and the PTC resistor R1 can be controlled such that it is proportional to the control voltage Ue present at the input of the operational amplifier X3. This control voltage as the setpoint value signal, specifies the heat output.

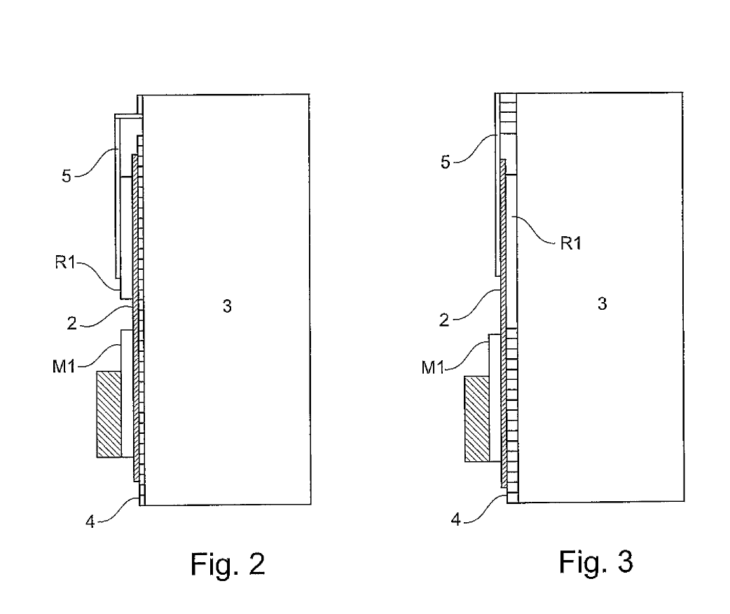

The field effect transistor M1 is a P-channel field effect transistor, preferably a P-channel MOSFET. The field effect transistor M1 and the PTC resistor R1 are mounted on a common heat sink made of metal. FIG. 2 shows, schematically, an embodiment of an assembly comprising a field effect transistor M1, a ceramic PTC resistor R1 and a sheet metal piece as the heat sink 2. The heat sink 2 can have nearly any shape and can comprise, for example, cooling fins and/or openings through which a medium to be heated flows. The heat sink 2 is fastened to a heater coil 3 common to all branch circuits, and is electrically insulated with respect thereto by way of an insulating layer 4 such as insulating sheet, ceramic or thermally conductive adhesive. A clamp 5 presses the resistor R1 against the heat sink 2 and induces ground contact.

FIG. 3 shows a further embodiment which differs from the embodiment in FIG. 2 mainly in that the field effect transistor M1 and the PTC resistor R1 are disposed on different sides of the heat sink 2. The clamp 5 is therefore electrically insulated with respect to the heater coil 3 which is used as a ground connection for the resistor R1.

The PTC resistor R1 is located at the same potential as the drain connector of the field effect transistor M1. Excellent thermal coupling of the PTC resistor to the field effect transistor can be achieved in this manner. If the heater has a plurality of branch circuits, a separate heat sink is preferably used for each branch circuit. The heat sinks of the individual branch circuits are then electrically insulated with respect to one another.

The PTC resistor R1 and the field effect transistor M1 should be matched to one another such that, at maximum heat output, the heat output of the PTC resistor R1 of a branch circuit is at least half as great as the heat output of the field effect transistor M1. On the other hand, at maximum heat output, the heat output of the PTC resistor R1 of a branch circuit should not be more than twice as great as the heat output of the field effect transistor M1. The maximum heat output is typically indicated by manufacturers as the maximum permissible heat output or rated output.

In this manner, both heating elements of a branch circuit, i.e. the field effect transistor M1 and the PTC resistor R1, contribute to the total heat output of the branch circuit in a comparable manner. The total output of a branch circuit, i.e. the maximum rated output of a branch circuit, is preferably between 100 and 200 watts.

What is claimed is:

1. An electric heater for a motor vehicle, the heater comprising:
at least one branch circuit, wherein a field effect transistor is connected in series to a resistor; and
a control circuit for regulating power, the control circuit being configured for taping a voltage signal between the field effect transistor and the resistor and, on the basis thereof and in combination with a setpoint value signal, generating an output signal at a control input of the field effect transistor, wherein the resistor is a ceramic PTC resistor mounted with the field effect transistor on a common heat sink.

2. The heater according to claim 1, wherein the field effect transistor is a P-channel field effect transistor, (a P-channel MOSFET).

3. The heater according to claim 1, wherein the control circuit comprises an operational amplifier, wherein the setpoint value signal is present at an input of the operational amplifier, and the voltage signal tapped between the field effect transistor and the PTC resistor is present at another input of the operational amplifier.

4. The heater according to claim 1, wherein the heat sink is made of metal and the PTC resistor is connected to the heat sink in an electrically conductive manner.

5. The heater according to claim 4, wherein the control circuit taps the voltage signal at the heat sink.

6. The heater according to claim 1, further comprising a plurality of branch circuits connected in parallel, in each having a field effect transistor connected in series to a ceramic PTC resistor; and
a control circuit for power regulation assigned to each of the branch circuits, each control circuit taping a voltage signal between the field effect transistor and the resistor of the branch circuit and, on the basis thereof and in combination with a setpoint value signal, generating an output signal at a control input of the field effect transistor of this branch circuit.

7. The heater according to claim 6, wherein one heat sink is provided for each branch circuit.

8. The heater according to claim 1, wherein, at a maximum heat output, heat output of the PTC resistor of a branch circuit is at least half as great as a heat output of the field effect transistor.

9. The heater according to claim 1, wherein, at maximum heat output, the heat output of the PTC resistor of a branch circuit is, at most, twice as great as the heat output of the field effect transistor.

10. An assembly for a heater according to claim 1, further comprising a P-channel field effect transistor and a metallic heat sink carrying the field effect transistor, wherein the heat sink carries a ceramic PTC resistor.
